(19) United States
(12) Patent Application Publication
(10) Pub. No.: US 2008/0064391 A1
(43) Pub. Date: Mar. 13, 2008

(54) CALL FORWARDING BETWEEN DIFFERENT TYPES OF WIRELESS NETWORKS

(76) Inventors: Yigang Cai, Naperville, IL (US); Alok Sharma, Lisle, IL (US)

Correspondence Address: DUFT BORNSEN & FISHMAN, LLP, 1526 SPRUCE STREET, SUITE 302, BOULDER, CO, 80302, US

(21) Appl. No.: 11/530,162

(22) Filed: Sep. 8, 2006

(51) Int. Cl. H04Q 7/20

(52) U.S. Cl. 455/426.1

(57) ABSTRACT

Communication networks and methods are disclosed that provide call forwarding between different types of wireless networks. If a wireless device is being served by a first wireless network and a call is initiated in a second wireless network, then a common or shared subscriber server is used to provide call forwarding. If a call forwarding condition (e.g., a busy condition or no answer condition) is detected in the first wireless network, then the first wireless network transmits a first call forwarding request message to the subscriber server. The subscriber server converts the first call forwarding request message in a first messaging protocol to a second call forwarding request message in a second messaging protocol. The subscriber server then transmits the second call forwarding request message to the second wireless network, and the second wireless network initiates forwarding of the call responsive to the second call forwarding request message.

### BACKGROUND OF THE INVENTION

1. Field of the Invention

The invention is related to the field of communication networks and, in particular, to handling call forwarding between different types of wireless networks.

2. Statement of the Problem

Call forwarding is a feature that allows calls to be routed to a directory number that is different than the dialed directory number. Wireless networks provide the feature of call forwarding for a variety of reasons. In one example, a subscriber may use call forwarding to have calls to his/her cell phone routed to an office phone or a home phone (e.g., “call forwarding all calls”). In another example, if a call to a subscriber cannot be connected because the subscriber does not answer or is busy, then the wireless network may forward the call to a voicemail server or to another number (e.g., “call forwarding don't answer” or “call forwarding busy”).

FIG. 1 illustrates a wireless network 100 that provides call forwarding in the prior art. Wireless network 100 includes a Mobile Switching Center (MSC) 110 that serves a wireless device 112, an MSC 120 that originates a call into wireless network 100, and a Home Location Register (HLR) 130. The following illustrates how wireless network 100 handles call forwarding for a call to wireless device 112.

Assume that calling party 122 initiates a call to wireless device 112. Originating MSC 120 receives the call and queries HLR 130 for the location of wireless device 112. HLR 130 queries the serving MSC 110 to determine the status of wireless device 112. Serving MSC 110 then pages wireless device 112 responsive to the query, and responds to HLR 130 as to whether wireless device 112 responded to the page (or subsequent pages). If wireless device 112 did not respond to one or more pages, then HLR 130 initiates early call forwarding for the call and responds to the query from originating MSC 120 with information on where to forward the call. If wireless device 112 did respond to a page, then HLR 130 responds to the query from originating MSC 120 with a Temporary Local Directory Number (TLDN) for serving MSC 110. Originating MSC 120 then routes the call to serving MSC 110 based on the TLDN provided by HLR 130.

Responsive to receiving the call, serving MSC 110 attempts to connect the call to wireless device 112. Assume at this point that serving MSC 110 detects a call forwarding condition. For example, serving MSC 110 may detect that wireless device 112 is busy or that wireless device 112 does not answer the call. If serving MSC 110 detects a call forwarding condition, then serving MSC 110 transmits a call forwarding request message to originating MSC 120. In a CDMA network, the call forwarding request message may be a Redirection Request (REDREQ) message. In a GSM network or a UMTS network, the call forwarding request message may be a ResumeCallHandlingRequest message. Responsive to the call forwarding request message, originating MSC 120 queries HLR 130 to determine where to forward the call. HLR 130 processes the subscriber profile associated with wireless device 112 to determine where to forward the call (e.g., to another directory number, to a voicemail server, etc), and responds to originating MSC 120 with forwarding information. Originating MSC 120 then forwards the call based on the forwarding information. Call forwarding at this point in a call is referred to herein as late call forwarding.

Some wireless service providers allow for dual mode service. Dual mode service allows a wireless device to communicate with different types of wireless networks that utilize different wireless protocols. As an example, dual mode service may allow a wireless device to communicate with different types of cellular networks, such as a CDMA network and a GSM network. In another example, dual mode service may allow a wireless device to communicate with a cellular network and a wireless data network, such as a CDMA network and an IMS network. Wireless devices that are able to receive a dual mode service are referred to as dual mode wireless devices.

One problem for network operators is handling call forwarding between different types of wireless networks, such as for a dual mode service. Call forwarding in wireless network 100 as described above can be easily handled by serving MSC 110 transmitting a call forwarding request message to originating MSC 120. However, if a wireless device is roaming such that the serving MSC and the originating MSC are in different types of wireless networks (e.g., a CDMA network and a GSM network), then the MSCs may not be able to communicate to provide call forwarding. The different types of wireless networks may not communicate using the same messaging protocol, so the MSC's of the different types of networks may not be able to communicate which is illustrated in FIG. 2.

FIG. 2 illustrates a communication network 200 that provides call forwarding in the prior art. Communication network 200 includes a GSM network 210, a CDMA network 220, and a common HLR 230. GSM network 210 includes an MSC 212, and CDMA network 220 includes an MSC 222. MSC 212 in GSM network 210 is adapted to serve a wireless device 216 that is roaming in GSM network 210.

Assume that a calling party 226 initiates a call to wireless device 216. Originating MSC 222 in CDMA network 220 receives the call and queries HLR 230 for the location of wireless device 216. HLR 230 queries the serving MSC 212 to determine the status of wireless device 216. Serving MSC 212 pages wireless device 216 responsive to the query, and then responds to HLR 230 as to whether wireless device 216 responded to the page (or subsequent pages). If wireless device 216 did not respond to one or more pages, then HLR 230 initiates early call forwarding for the call and responds to the query from originating MSC 222 with information on where to forward the call. If wireless device 216 did respond to a page, then HLR 230 responds to the query from originating MSC 222 with a TLDN for serving MSC 212. Originating MSC 222 then routes the call to serving MSC 212 based on the TLDN provided by HLR 230.

Responsive to receiving the call, serving MSC 212 attempts to connect the call to wireless device 216. Assume at this point that serving MSC 212 detects a call forwarding condition. One problem is that serving MSC 212 cannot simply transmit a call forwarding request message to originating MSC 222 because serving MSC 212 communicates using a different messaging protocol than originating MSC 222. In FIG. 2, serving MSC 212 uses GSM MAP messaging whereas originating MSC 222 uses ANSI messaging. As a result, serving MSC 212 is unable to transmit a call forwarding request message to originating MSC 222 and is unable to initiate call forwarding for the call to wireless device 216.

### SUMMARY OF THE SOLUTION

The invention solves the above and other related problems by using a subscriber server, such as an HLR or a combined HLR/HSS, to handle call forwarding between different types of wireless networks. The subscriber server is adapted to interwork call forwarding messages between two different types of wireless networks to allow the wireless networks to communicate for the purposes of call forwarding (and possibly for the purposes of providing other features). The subscriber server thus provides an effective solution for handing call forwarding for roaming wireless devices.

In one embodiment of the invention, a communication network includes a first wireless network, a second wireless network, and a subscriber server. An example of the first wireless network may be a CDMA network while an example of the second wireless network may be a GSM network. The first wireless network includes a serving call control function adapted to communicate with a wireless device. The second wireless network includes an originating call control function adapted to receive a call to the wireless device, and to route the call to the serving call control function. The serving call control function is adapted receive the call to the wireless device. If a call forwarding condition (e.g., a busy condition or don't answer condition) is detected, then the serving call control function is further adapted to transmit a first call forwarding request message to the subscriber server. The first call forwarding request message is in a first messaging protocol used by the first wireless network. The subscriber server (e.g., an HLR or a combined HLR/HSS) is adapted to convert the first call forwarding request message in the first messaging protocol to a second call forwarding request message in a second messaging protocol. The second messaging protocol is the protocol used by the second wireless network for messaging. The subscriber server is adapted to transmit the second call forwarding request message in the second messaging protocol to the originating call control function. The originating call control function is adapted to initiate forwarding of the call responsive to the second call forwarding request message.

The invention may include other exemplary embodiments described below.

### DESCRIPTION OF THE DRAWINGS

The same reference number represents the same element or same type of element on all drawings.

FIG. 1 illustrates a wireless network that provides call forwarding in the prior art.

FIG. 2 illustrates a communication network that provides call forwarding in the prior art.

FIG. 3 illustrates a communication network in an exemplary embodiment of the invention.

FIG. 4 is a flow chart illustrating a method of operating a communication network to provide call forwarding in an exemplary embodiment.

FIG. 5 illustrates an exemplary embodiment of a subscriber server.

FIG. 6 is a flow chart illustrating a method of operating a subscriber server in an exemplary embodiment.

FIG. 7 is a flow chart illustrating a method of converting a call forwarding request message from one protocol to another in an exemplary embodiment.

FIG. 8 is a flow chart illustrating a method of transmitting forwarding information for a call in an exemplary embodiment.

FIG. 9 illustrates a communication network comprised of different types of wireless networks in an exemplary embodiment.

FIG. 10 is a message diagram illustrating call forwarding between a CDMA network and a GSM network in an exemplary embodiment.

FIG. 11 is a message diagram illustrating call forwarding between a GSM network and a CDMA network in an exemplary embodiment.

FIG. 12 is a message diagram illustrating call forwarding between an IMS network and a GSM network in an exemplary embodiment.

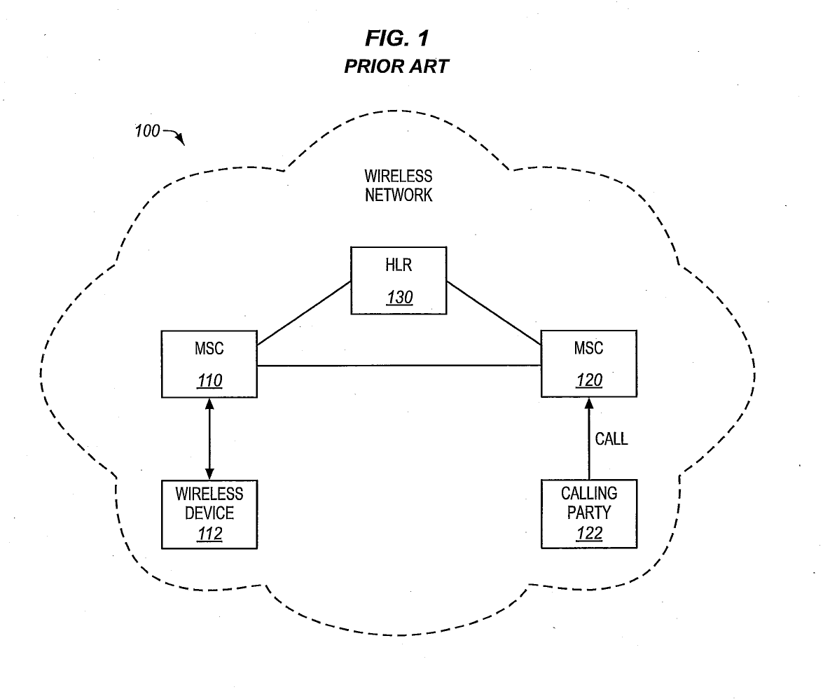

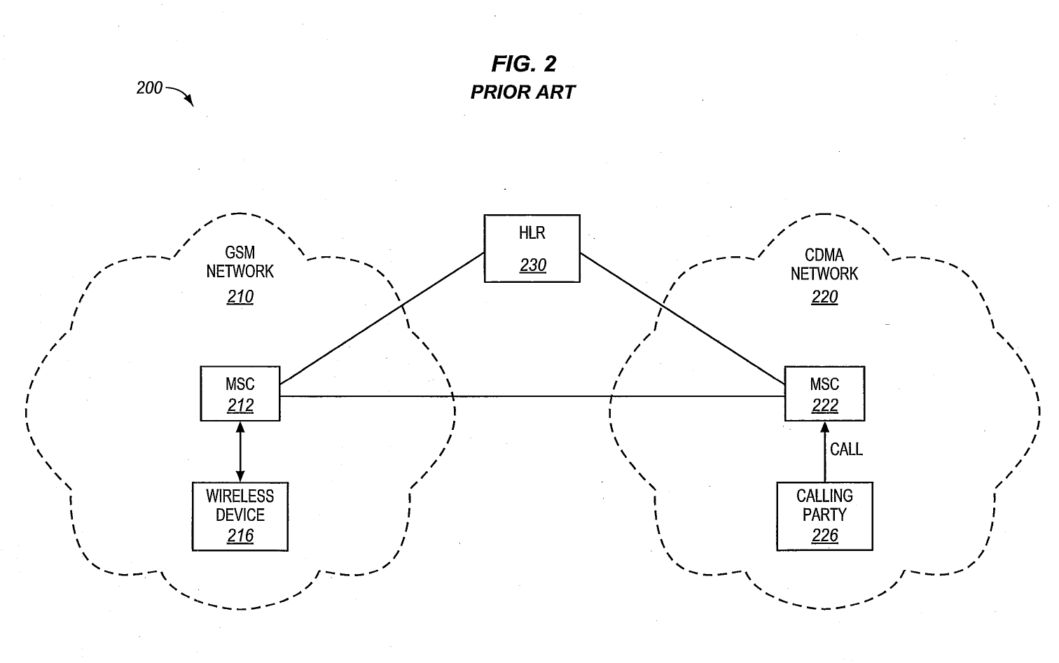

### DETAILED DESCRIPTION OF THE INVENTION

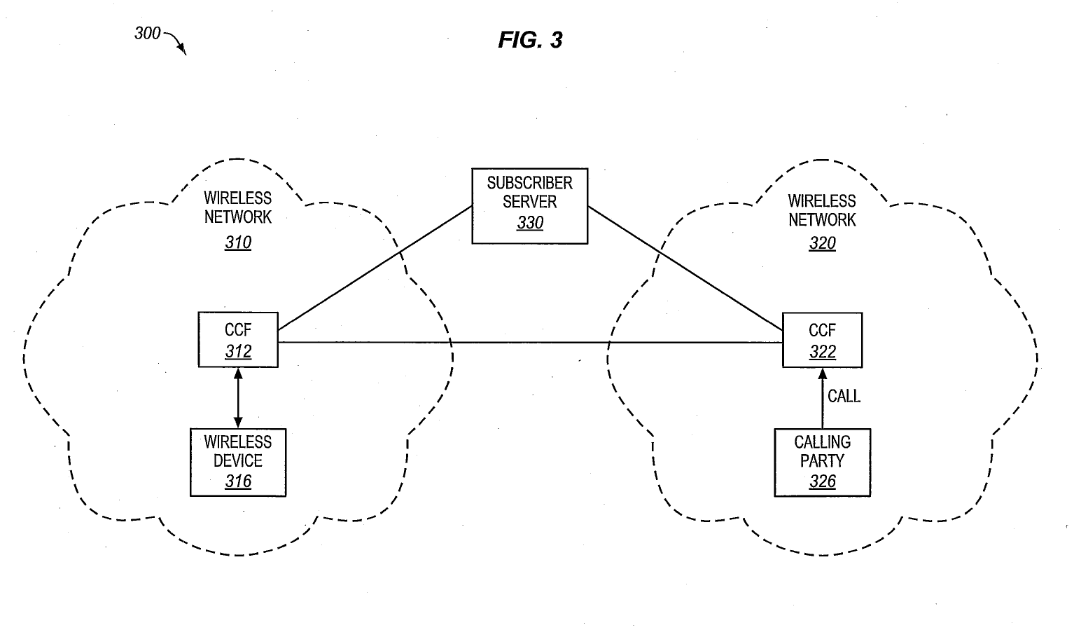

FIGS. 3-12 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 3 illustrates a communication network 300 in an exemplary embodiment of the invention. Communication network 300 includes a first wireless network 310, a second wireless network 320, and a subscriber server 330. The network clouds illustrating the networks are not being used to show the actual service areas of the networks, as the service areas may be separate or overlap. Subscriber server 330 is shown as being outside of wireless networks 310 and 320, but subscriber server 330 may be implemented in either or both of networks 310 and 320 or may be implemented in a remote system. Communication network 300 may include other networks, systems, or devices not shown in FIG. 3, such as base stations.

Wireless network 310 and wireless network 320 each comprise any network that provides communications via wireless signals. Wireless network 310 and wireless network 320 are different types of wireless networks meaning that they communicate using different types of wireless protocols. In one example, wireless network 310 may be a CDMA network while wireless network 320 may be a GSM network. In another example, wireless network 310 may be a CDMA network while wireless network 320 may be a UMTS network. In another example, wireless network 310 may be a CDMA network while wireless network 320 may be an IMS network.

Wireless network 310 includes a call control function (CCF) 312. A call control function (CCF) comprises any system, network node, software application, etc., adapted to serve a call, such as an MSC in a CDMA or GSM network, or a Call Session Control Function (CSCF) or an Application Server (AS) in an IMS network. Wireless network 320 includes a CCF 322.

CCF 312 is illustrated in FIG. 3 as serving a wireless device 316. Wireless device 316 comprises any device adapted to communicate via wireless signals, such as a mobile phone, a PDA, a mobile VoIP phone, etc. Wireless device 316 may be a dual mode wireless device, meaning that wireless device 316 is able to communicate with wireless network 310 and wireless network 320 that utilize different wireless protocols.

Subscriber server 330 comprises any database or similar system that stores and maintains subscriber information or subscriber data for one or more subscribers. For instance, subscriber server 330 may maintain subscriber data in the form of a subscriber record or subscriber profile for a user of wireless device 316. Subscriber server 330 is accessible by either wireless network 310 or wireless network 320 so that either network 310 or 320 may retrieve subscriber data or other information. Subscriber server 330 may comprise a single centralized system or may be distributed among multiple systems. If implemented in multiple systems, the systems communicate to maintain common subscriber data. Subscriber server 330 may comprise a Home Location Register (HLR), such as a Super-Distributed HLR (S-DHLR) from Lucent Technologies. Subscriber server 330 may alternatively comprise a combined Home Location Register (HLR)/Home Subscriber Server (HSS).

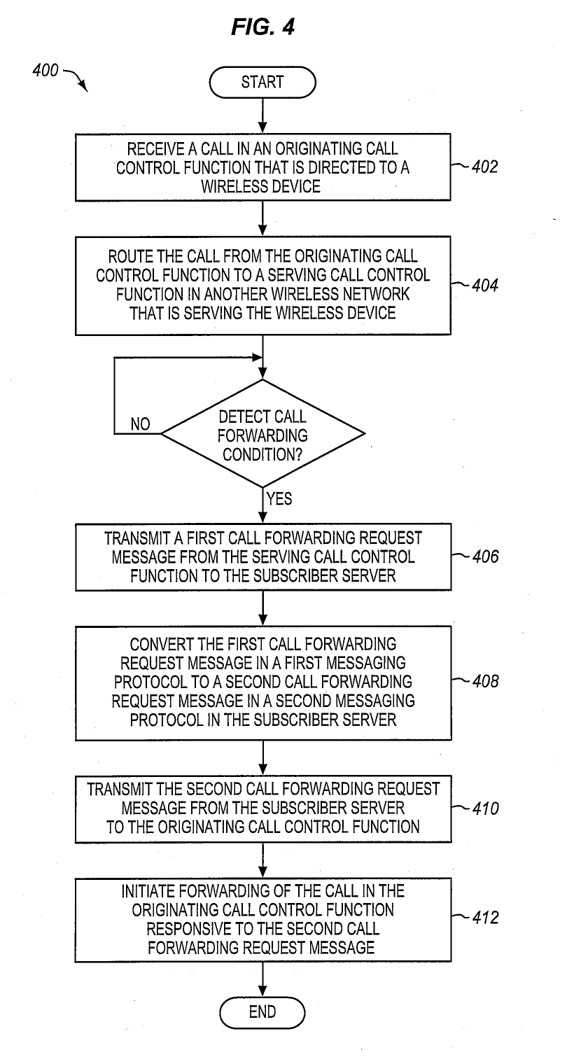

FIG. 4 is a flow chart illustrating a method 400 of operating a communication network to provide call forwarding in an exemplary embodiment of the invention. The steps of method 400 will be described with reference to communication network 300 in FIG. 3. The steps of the flow chart in FIG. 4 are not all inclusive and may include other steps not shown.

In step 402 of method 400, CCF 322 in wireless network 320 receives a call to wireless device 316 from a calling party 326. CCF 322 may query subscriber server 330 as to where to route the call. Because CCF 312 in wireless network 310 is presently serving wireless device 316, CCF 322 routes the call to CCF 312 in step 404. Responsive to receiving the call (e.g., receiving call setup messages for the call), if CCF 312 detects a call forwarding condition, then CCF 312 transmits a first call forwarding request message to subscriber server 330 in step 406. A call forwarding condition comprises some scenario, situation, or circumstance encountered by CCF 312 during the call where forwarding of the call is required or desired. In one example of a call forwarding condition, CCF 312 may attempt to connect the call to wireless device 316 and may detect that wireless device 316 is unavailable (no answer). In another example of a call forwarding condition, CCF 312 may attempt to connect the call to wireless device 316 and may detect that wireless device 316 is busy. CCF 312 may detect other scenarios that comprise a call forwarding condition. Call forwarding at this point in a call is referred to herein as late call forwarding.

The first call forwarding request message transmitted by CCF 312 to subscriber server 330 is in a first messaging protocol used by wireless network 310 for messaging. The first messaging protocol used by CCF 312 is different than a second messaging protocol used by CCF 322 of wireless network 320. For instance, wireless network 310 may be a CDMA network and wireless network 320 may be a GSM network. In such an example, the first messaging protocol of the CDMA network is ANSI while the second messaging protocol of the GSM network is GSM MAP. In another instance, wireless network 310 may be a GSM network and wireless network 320 may be an IMS network. In such an example, the first messaging protocol of the GSM network is GSM MAP while the second messaging protocol of the IMS network is SIP (or possibly Diameter).

In step 408 of method 400, subscriber server 330 converts the first call forwarding request message in the first messaging protocol of wireless network 310 to a second call forwarding request message in the second messaging protocol of wireless network 320. In step 410, subscriber server 330 transmits the second call forwarding request message in the second messaging protocol to CCF 322. Subscriber server 330 thus acts as an interworking point between wireless network 310 and wireless network 320 to translate messaging between the networks.

In step 412, CCF 322 then initiates forwarding of the call responsive to the second call forwarding request message. To initiate forwarding of the call, CCF 322 may transmit a query to subscriber server 330 to determine where to forward the call. CCF 322 may then receive a response to the query from subscriber server 330 that includes forwarding information for the call, and forward the call according to the forwarding information.

Communication network 300 as described in FIGS. 3-4 advantageously provides an effective way of providing call forwarding between two different types of wireless networks. Subscriber server 330 acts as a redirect switching node in communication network 300 to provide call forwarding. A call control function of one wireless network may thus transmit a call forwarding request message to subscriber server 330, which will in turn translate the call forwarding request message to a protocol suitable for another wireless network. Call control functions of different wireless networks can thus communicate with each other through subscriber server 330 to provide features such as call forwarding.

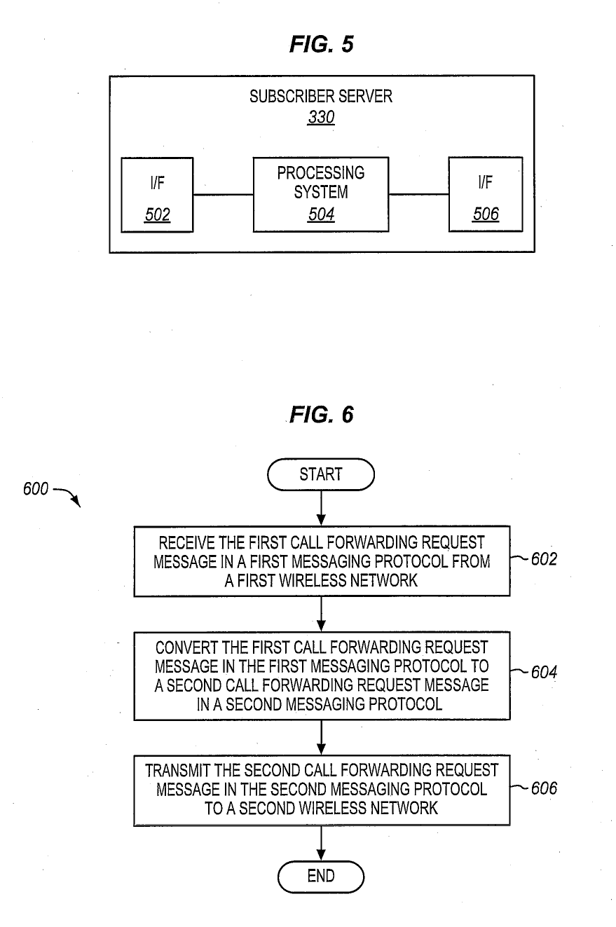

FIG. 5 illustrates an exemplary embodiment of subscriber server 330. In this embodiment, subscriber server 330 includes a first interface 502, a processing system 504, and a second interface 506. Interface 502 is adapted to communicate with wireless network 310 illustrated in FIG. 3, such as by communicating with CCF 312. Interface 506 is adapted to communicate with wireless network 320 illustrated in FIG. 3, such as by communicating with CCF 322. Subscriber server 330 may include other interfaces to communicate with other types of wireless networks. Processing system 504 is adapted to provide an interworking function to convert messages between the different protocols used by the different types of wireless networks. Processing system 504 may be implemented as software, hardware, or a combination of hardware and software. In a software implementation, processing system 504 may execute instructions that are stored on storage media. Some examples of instructions are software, program code, and firmware. Some examples of storage media are memory devices, tape, disks, integrated circuits, and servers. The instructions are operational when executed by processing system 504 to direct processing system 504 to operate in accordance with the invention. The term “processing system” refers to a single processing device or a group of inter-operational processing devices. Some examples of processors are computers, integrated circuits, and logic circuitry.

FIG. 6 is a flow chart illustrating a method 600 of operating subscriber server 330 in an exemplary embodiment. In step 602 of method 600, interface 502 receives a first call forwarding request message from wireless network 310 (see FIG. 3). Interface 502 receives the first call forwarding request message responsive to CCF 312 in wireless network 310 detecting a call forwarding condition for a call to wireless device 316. The first call forwarding request message from wireless network 310 is in a first messaging protocol used by wireless network 310. In step 604, processing system 504 converts the first call forwarding request message in the first messaging protocol to a second call forwarding request message in a second messaging protocol. The second messaging protocol is the protocol used by wireless network 320 (see FIG. 3) that originated the call to wireless device 316. In step 606, interface 506 transmits the second call forwarding request message in the second messaging format to wireless network 320 (see FIG. 3).

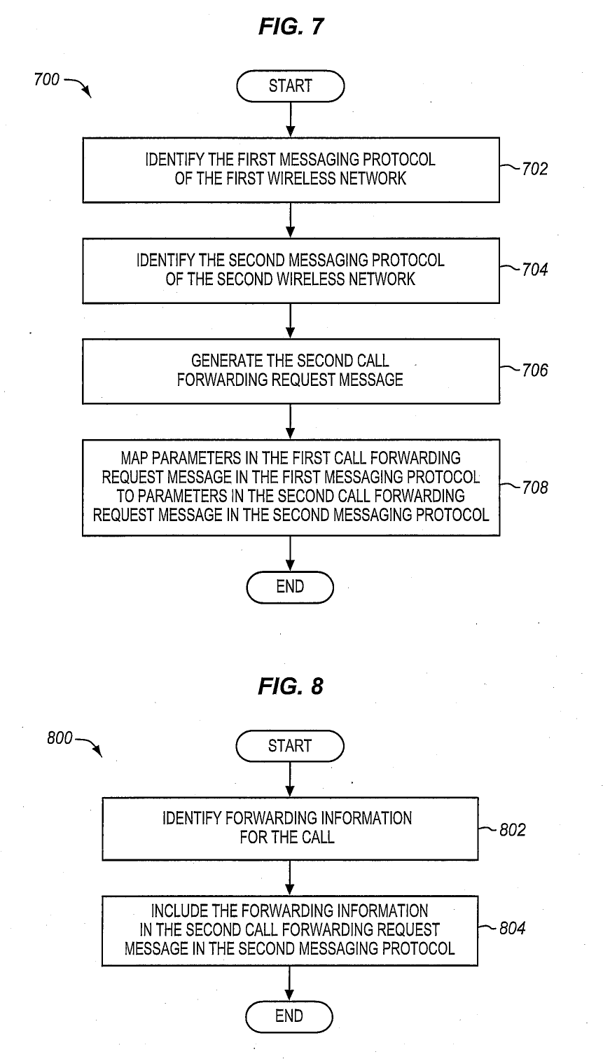

FIG. 7 is a flow chart illustrating a method 700 of converting a call forwarding request message from one protocol to another in an exemplary embodiment. As stated in step 602 of FIG. 6, a first call forwarding request message is received that is in a first messaging format. Responsive to receiving the first call forwarding request message, processing system 504 identifies the first messaging protocol of wireless network 310 in step 702 of method 700, such as ANSI for a CDMA network or GSM MAP for a GSM or UMTS network. Processing system 504 also identifies the second messaging protocol of wireless network 320 in step 704. To identify the messaging protocols, processing system 504 may maintain a database of information on the wireless networks served by subscriber server 330. Processing system 504 may thus identify the messaging protocols of wireless networks 310 and 320 from the information stored in the database. In an alternative, processing system 504 may query each individual wireless network to identify the messaging protocol used by each individual wireless network. In another alternative, processing system 504 may be able to process messages received from the wireless networks to identify the protocol being used.

When the messaging protocols are identified, processing system 504 generates a second call forwarding request message in step 706. Processing system 504 then maps parameters in the first call forwarding request message that is in the first messaging protocol to parameters in the second call forwarding request message that is in the second messaging protocol. Processing system 504 may map the parameters according to many desired methods so that information in the first call forwarding request message that is needed for call forwarding is included in the second call forwarding request message.

FIG. 8 is a flow chart illustrating a method of transmitting forwarding information for a call in an exemplary embodiment. In FIG. 6 step 606, interface 506 transmits the second call forwarding request message in the second messaging format to wireless network 320. Subscriber server 330 may also provide forwarding information in the second call forwarding request message. For instance, in step 802 of FIG. 8, processing system 504 of subscriber server 330 may identify forwarding information for the call responsive to receiving the first call forwarding request message. Processing system 504 may process a subscriber profile or other data to identify the forwarding information. In step 804, processing system 504 may then include the forwarding information in the second call forwarding request message. The receiving CCF consequently has the forwarding information provided by subscriber server 330 and does not have to go through another messaging sequence with subscriber server 330 in order to receive the forwarding information.

### EXAMPLES

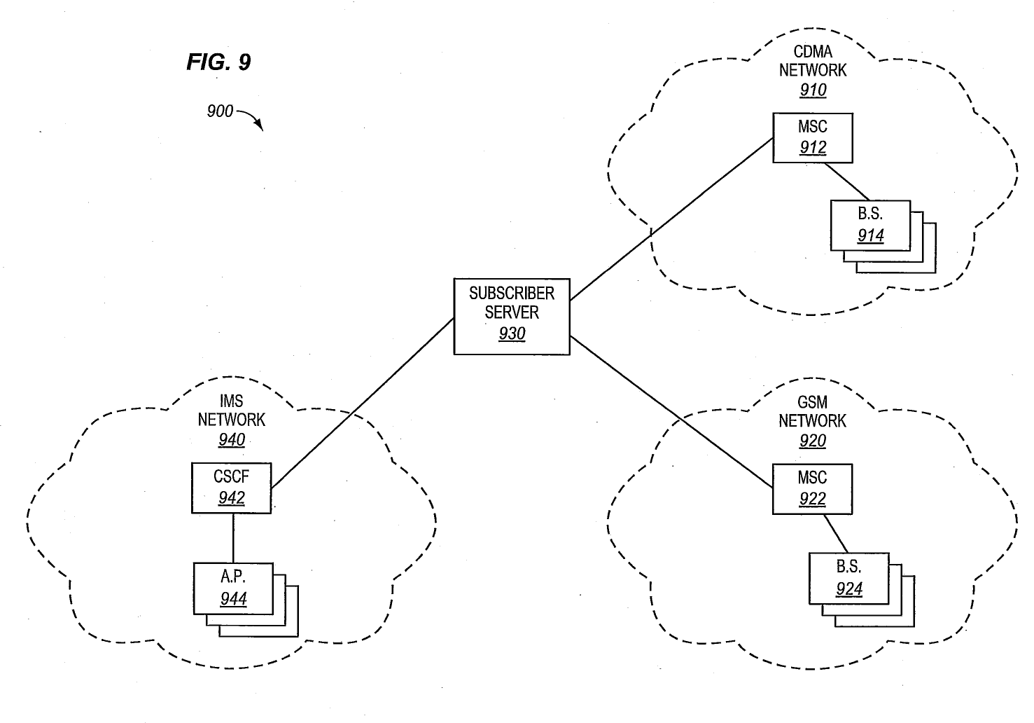

FIGS. 9-12 illustrate examples of how to perform call forwarding between different types of wireless networks. FIG. 9 illustrates a communication network 900 comprised of different types of wireless networks in an exemplary embodiment. Communication network 900 includes a CDMA network 910, a GSM network 920, a mobile IMS network 940, and a subscriber server 930. The network clouds illustrating the networks are not being used to show the actual service areas of the networks, as the service areas may be separate or overlap. Networks 910, 920, and 940, and subscriber server 930, may be managed by the same service provider, such as Verizon, Sprint, Cingular, etc, or they may be managed by different service providers. These types of wireless networks are just examples to illustrate how to use the subscriber server 930 to provide call forwarding. A similar operation may be extended to other types of wireless networks not shown.

CDMA network 910 includes a Mobile Switching Center (MSC) 912 and a plurality of base stations (B.S.) 914. Base stations 914 are adapted to communicate with wireless devices according CDMA standards. MSC 912 is adapted to communicate with subscriber server 930 according to ANSI protocol. MSC 912 also includes a Visitor Location Register (VLR) to handle roaming devices.

GSM network 920 includes an MSC 922 and a plurality of base stations (B.S.) 924. Base stations 924 are adapted to communicate with wireless devices according GSM standards. MSC 922 is adapted to communicate with subscriber server 930 according to GSM MAP protocol. MSC 922 also includes a Visitor Location Register (VLR) to handle roaming devices.

IMS network 940 includes a Call Session Control Function (CSCF) 942 and a plurality of access points (A.P.) 944. Access points 944 are adapted to communicate with wireless devices according to a desired wireless standard. For instance, access points 944 may comprise WiFi access points operating according to 802.11(b) standards, 802.11(g) standards, etc. CSCF 942 is adapted to communicate with subscriber server 930 according to SIP and/or Diameter protocol.

Subscriber server 930 is adapted to serve CDMA network 910, GSM network 920, and IMS network 940 to provide subscriber information to the networks. Subscriber server 930 may include the functionality of a CDMA HLR, a GSM HLR, and an IMS HSS to serve these different types of networks. Subscriber server 930 may be referred to as a Super-Distributed HLR (S-DLR) from Lucent Technologies. Subscriber server 930 may also be referred to as a combined HLR/HSS.

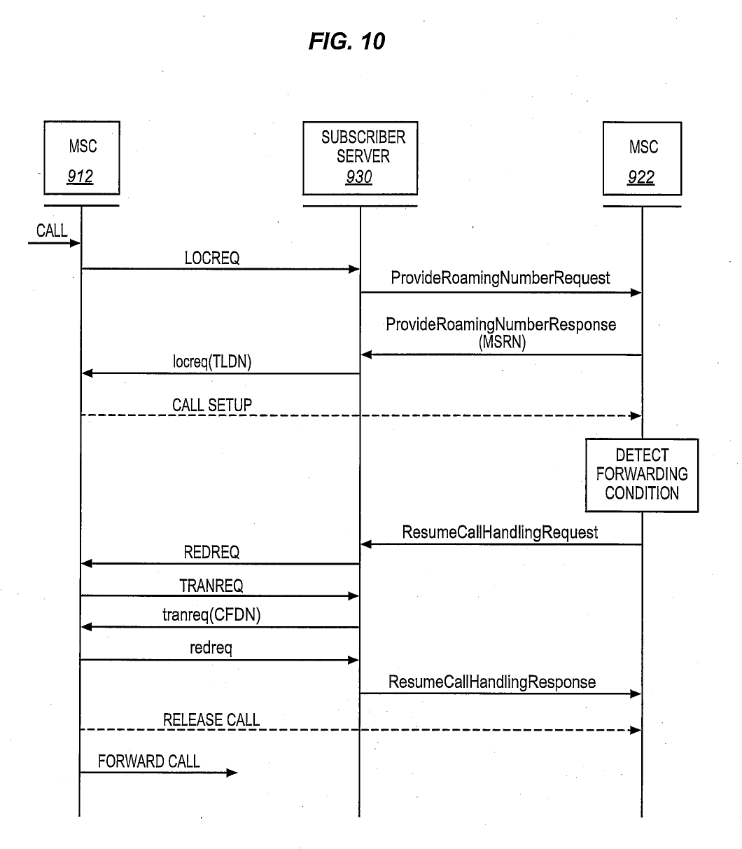

FIG. 10 is a message diagram illustrating call forwarding between a CDMA network and a GSM network in an exemplary embodiment. Assume for this embodiment that a wireless device is roaming in GSM network 920. The wireless device may belong to a subscriber that subscribes to a CDMA service, but the wireless device has dual-mode capabilities allowing the wireless device to roam in GSM network 920. Further assume that a call is initiated to the wireless device in CDMA network 910.

MSC 912 in CDMA network 910 receives the incoming call as the originating MSC. Responsive to receiving the call, originating MSC 912 generates an ANSI Location Request (LOCREQ) message and transmits the LOCREQ message to subscriber server 930. Subscriber server 930 processes the “Dynamic Common Subscriber Data” in the subscriber profile associated with the wireless device to determine that the wireless device is presently roaming in GSM network 920. Subscriber server 930 then converts the ANSI LOCREQ message to a GSM MAP ProvideRoamingNumberRequest message by mapping information from the LOCREQ message and the subscriber profile into parameters of the ProvideRoamingNumberRequest message. Subscriber server 930 then transmits the ProvideRoamingNumberRequest message to MSC 922 that is serving the wireless device in GSM network 920. Responsive to the ProvideRoamingNumberRequest message, serving MSC 922 pages the wireless device. If the wireless device acknowledges the page, then serving MSC 922 transmits a GSM MAP ProvideRoamingNumberResponse message to subscriber server 930. The ProvideRoamingNumberResponse message includes the routing information Mobile Station Routing Number (MSRN) for the wireless device in GSM network 920. Subscriber server 930 converts the GSM MAP ProvideRoamingNumberResponse message to an ANSI locreq message by mapping the information received in the GSM MAP ProvideRoamingNumberResponse message into parameters in the ANSI locreq message, including the MSRN as a TLDN. Subscriber server 930 then transmits the ANSI locreq message to originating MSC 912.

Originating MSC 912 then routes the call to serving MSC 922 based on the TLDN. Serving MSC 922 may then operate in a conventional manner to attempt to connect the call to the wireless device. If serving MSC 922 detects a call forwarding condition, such as the wireless device being busy or not answering, then serving MSC 922 transmits a GSM MAP ResumeCallHandlingRequest message to subscriber server 930. Subscriber server 930 converts the GSM MAP ResumeCallHandlingRequest message to an ANSI Redirection Request (REDREQ) message by mapping the information received in the GSM MAP ResumeCallHandlingRequest message into parameters in the ANSI REDREQ message. Subscriber server 930 then transmits the REDREQ message to originating MSC 912, which initiates the redirection sequence of the call in CDMA network 910.

Responsive to receiving the REDREQ message, originating MSC 912 transmits an ANSI Transaction Request (TRANREQ) message to subscriber server 930 to request call forwarding information from subscriber server 930. Subscriber server 930 transmits an ANSI tranreq message to originating MSC 912 that includes a call forwarding directory number (CFDN) for the call. Originating MSC 912 then transmits an ANSI redreq message to subscriber server 930 to acknowledge that the call forwarding directory number was received. Subscriber server 930 also transmits a GSM MAP ResumeCallHandlingResponse message to serving MSC 922 to instruct serving MSC 922 to release the call.

Responsive to receiving the call forwarding directory number, originating MSC 912 releases the connection to serving MSC 922. Originating MSC 912 also sets up a new connection to the call forwarding directory number to forward the call to the call forwarding directory number.

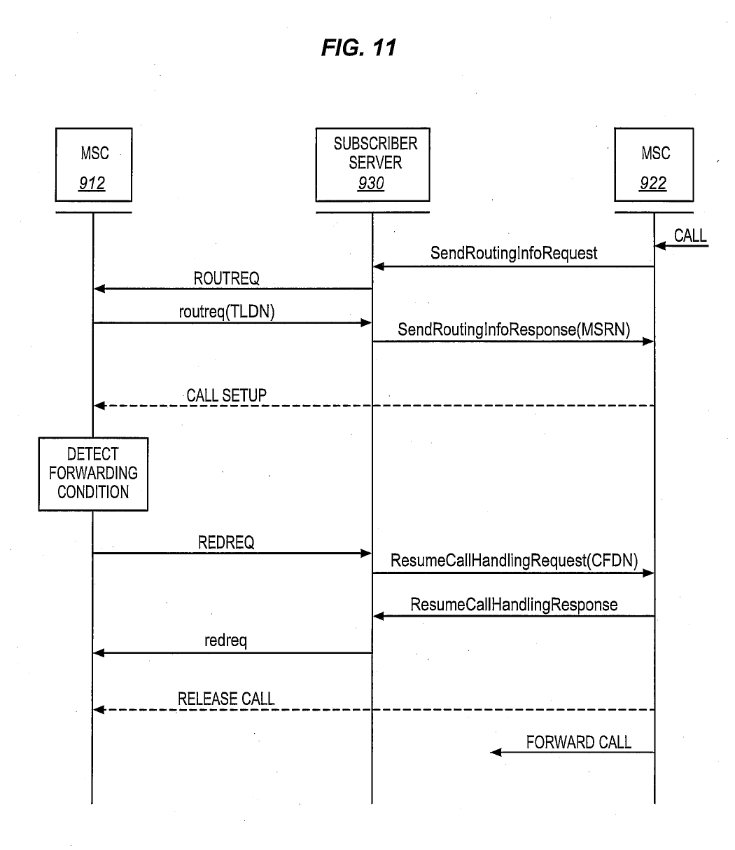

FIG. 11 is a message diagram illustrating call forwarding between a GSM network and a CDMA network in an exemplary embodiment. Assume for this embodiment that a wireless device is roaming in CDMA network 910. The wireless device may belong to a subscriber that subscribes to a GSM service, but the wireless device has dual-mode capabilities allowing the wireless device to roam in CDMA network 910. Further assume that a call is initiated to the wireless device in GSM network 920.

MSC 922 in GSM network 920 receives the incoming call as the originating MSC. Responsive to receiving the call, originating MSC 922 generates a GSM MAP SendRoutingInfoRequest message and transmits the SendRoutingInfoRequest message to subscriber server 930. Subscriber server 930 processes the “Dynamic Common Subscriber Data” in the subscriber profile associated with the wireless device to determine that the wireless device is presently roaming in CDMA network 910. Subscriber server 930 then converts the GSM MAP SendRoutingInfoRequest message to an ANSI Routing Request (ROUTREQ) message by mapping information from the SendRoutingInfoRequest message and the subscriber profile into parameters of the ROUTREQ message. Subscriber server 930 then transmits the ROUTREQ message to MSC 912 that is serving the wireless device in CDMA network 910. Responsive to the request message, serving MSC 912 pages the wireless device. If the wireless device acknowledges the page, then serving MSC 912 transmits an ANSI routreq message to subscriber server 930. The routreq message includes the routing information TLDN for the wireless device in CDMA network 910. Subscriber server 930 converts the ANSI routreq message to a GSM MAP SendRoutingInfoResponse message by mapping the information received in the ANSI routreq message into parameters in the GSM MAP SendRoutingInfoResponse message, including the TLDN as an MSRN. Subscriber server 930 then transmits the GSM MAP SendRoutingInfoResponse message to originating MSC 922.

Originating MSC 922 then routes the call to serving MSC 912 based on the MSRN. Serving MSC 912 may then operate in a conventional manner to attempt to connect the call to the wireless device. If serving MSC 912 detects a call forwarding condition, such as the wireless device being busy or not answering, then serving MSC 912 transmits an ANSI REDREQ message to subscriber server 930. Subscriber server 930 converts the REDREQ message to a GSM MAP ResumeCallHandlingRequest message by mapping the information received in the ANSI REDREQ message into parameters in the GSM MAP ResumeCallHandlingRequest message. Subscriber server 930 also determines a call forwarding directory number (CFDN) for the call, and includes the call forwarding directory number in the GSM MAP ResumeCallHandlingRequest message. Subscriber server 930 then transmits the ResumeCallHandlingRequest message to originating MSC 922, which initiates the redirection sequence of the call in GSM network 920.

Originating MSC 922 transmits a GSM MAP ResumeCallHandlingResponse message to subscriber server 930 to acknowledge that the call forwarding directory number was received. Subscriber server 930 also transmits an ANSI redreq message to serving MSC 912 to instruct serving MSC 912 to release the call.

Responsive to receiving the call forwarding directory number, originating MSC 922 releases the connection to serving MSC 912. Originating MSC 922 also sets up a new connection to the call forwarding directory number to forward the call to the call forwarding directory number.

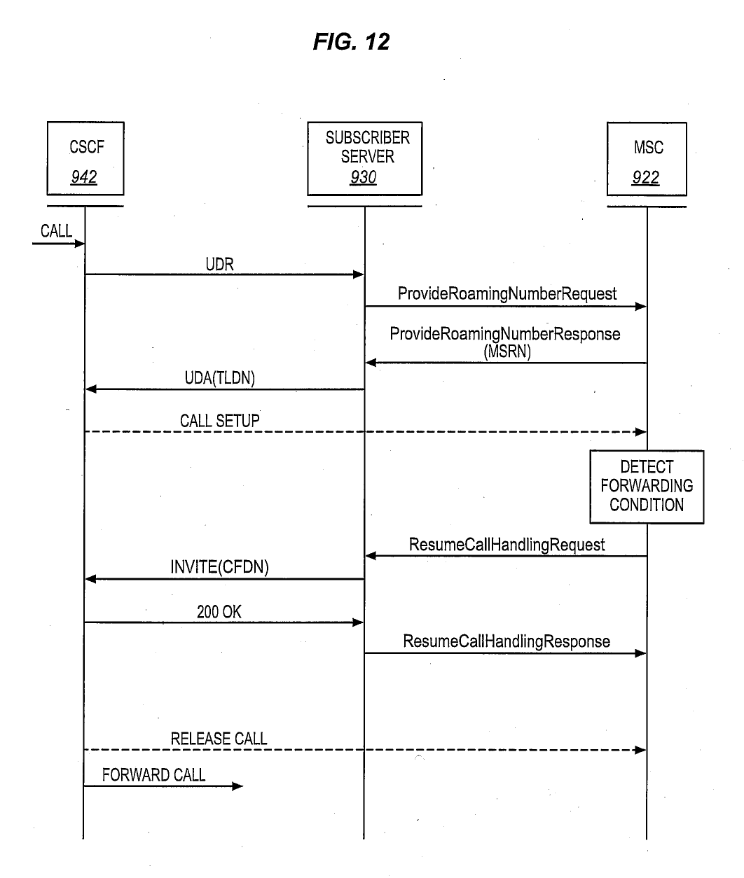

FIG. 12 is a message diagram illustrating call forwarding between an IMS network and a GSM network in an exemplary embodiment. Assume for this embodiment that a wireless device is roaming in GSM network 920. The wireless device may belong to a subscriber that subscribes to an IMS service, but the wireless device has dual-mode capabilities allowing the wireless device to roam in GSM network 920. Further assume that a call is initiated to the wireless device in IMS network 940.

CSCF 942 in IMS network 940 receives the incoming call. Responsive to receiving the call, CSCF 942 generates a Diameter User Data Request (UDR) message and transmits the UDR message to subscriber server 930. Subscriber server 930 processes the “Dynamic Common Subscriber Data” in the subscriber profile associated with the wireless device to determine that the wireless device is presently roaming in GSM network 920. Subscriber server 930 then converts the Diameter UDR message to a GSM MAP ProvideRoamingNumberRequest message by mapping information from the Diameter UDR message and the subscriber profile into parameters of the GSM MAP ProvideRoamingNumberRequest message. Subscriber server 930 then transmits the ProvideRoamingNumberRequest message to MSC 922 that is serving the wireless device in GSM network 920.

Responsive to the ProvideRoamingNumberRequest message, serving MSC 922 pages the wireless device. If the wireless device acknowledges the page, then serving MSC 922 transmits a GSM MAP ProvideRoamingNumberResponse message to subscriber server 930. The ProvideRoamingNumberResponse message includes the routing information MSRN for the wireless device in GSM network 920. Subscriber server 930 converts the GSM MAP ProvideRoamingNumberResponse message to a Diameter User Data Answer (UDA) message by mapping the information received in the GSM MAP ProvideRoamingNumberResponse message into parameters in the Diameter UDA message, including the MSRN as a TLDN. Subscriber server 930 then transmits the Diameter UDA message to CSCF 942.

CSCF 942 then routes the call to serving MSC 922 based on the TLDN. Serving MSC 922 may then operate in a conventional manner to attempt to connect the call to the wireless device. If serving MSC 922 detects a call forwarding condition, such as the wireless device being busy or not answering, then serving MSC 922 transmits a GSM MAP ResumeCallHandlingRequest message to subscriber server 930. Subscriber server 930 converts the GSM MAP ResumeCallHandlingRequest message to a SIP INVITE message by mapping the information received in the GSM MAP ResumeCallHandlingRequest message into parameters in the SIP INVITE message. Subscriber server 930 also determines a call forwarding directory number (CFDN) for the call, and includes the call forwarding directory number in the SIP INVITE message. Subscriber server 930 then transmits the SIP INVITE message to CSCF 942, which initiates the redirection sequence of the call in IMS network 940.

Responsive to receiving the SIP INVITE message, CSCF 9422 transmits a SIP 200 OK message to subscriber server 930 to acknowledge that the call forwarding directory number was received. Subscriber server 930 also transmits a GSM MAP ResumeCallHandlingResponse message to serving MSC 922 to instruct serving MSC 922 to release the call.

Responsive to receiving the call forwarding directory number, CSCF 942 releases the connection to serving MSC 922. CSCF 942 also sets up a new connection to the call forwarding directory number to forward the call to the call forwarding directory number.

Although specific embodiments were described herein, the scope of the invention is not limited to those specific embodiments. The scope of the invention is defined by the following claims and any equivalents thereof.

We claim:

1. A communication network for providing call forwarding for calls to a wireless device, the communication network comprising:
a subscriber server adapted to store subscriber information for a subscriber using a wireless device;
a first wireless network having a serving call control function adapted to communicate with the wireless device;
a second wireless network having an originating call control function adapted to receive a call directed to the wireless device, and to route the call to the serving call control function;
the serving call control function is adapted to receive the call to the wireless device, and if a call forwarding condition is detected, then the serving call control function is further adapted to transmit a first call forwarding request message to the subscriber server in a first messaging protocol;
the subscriber server is adapted to convert the first call forwarding request message in the first messaging protocol of the first wireless network to a second call forwarding request message in a second messaging protocol of the second wireless network, and to transmit the second call forwarding request message in the second messaging protocol to the originating call control function; and
the originating call control function is adapted to initiate forwarding of the call responsive to the second call forwarding request message.

2. The communication network of claim 1 wherein the originating call control function is further adapted to:
transmit a query to the subscriber server to determine where to forward the call responsive to receiving the second call forwarding request message;
receive a response to the query that includes forwarding information for the call; and
forward the call according to the forwarding information.

3. The communication network of claim 1 wherein the subscriber server is further adapted to:
identify forwarding information for the call responsive to receiving the first call forwarding request message; and
include the forwarding information in the second call forwarding request message.

4. The communication network of claim 1 wherein the subscriber server is further adapted to:
identify the first messaging protocol of the first wireless network;
identify the second messaging protocol of the second wireless network;
generate the second call forwarding request message; and
map parameters in the first call forwarding request message in the first messaging protocol to parameters in the second call forwarding request message in the second messaging protocol.

5. The communication network of claim 1 wherein the subscriber server is further adapted to convert the first call forwarding request message in a GSM MAP protocol to the second call forwarding request message in an ANSI protocol, or vice-versa.

6. The communication network of claim 1 wherein the subscriber server is further adapted to convert the first call forwarding request message in a GSM MAP protocol to the second call forwarding request message in Session Initiation Protocol (SIP), or vice-versa.

7. The communication network of claim 1 wherein the subscriber server is further adapted to convert the first call forwarding request message in an ANSI protocol to the second call forwarding request message in Session Initiation Protocol (SIP), or vice-versa.

8. The communication network of claim 1 wherein the subscriber server comprises a Home Location Register (HLR) or a combined Home Location Register (HLR)/Home Subscriber Server (HSS).

9. The communication network of claim 1 wherein the call forwarding condition comprises one of a call forwarding don't answer or a call forwarding busy.

10. A method of operating a communication network for providing call forwarding for calls to a wireless device, wherein the communication network includes a first wireless network, a second wireless network, and a subscriber server, the method comprising:
serving a wireless device through the first wireless network;
receiving a call to the wireless device in the second wireless network, and routing the call to the first wireless network;
detecting a call forwarding condition in the first wireless network;
transmitting a first call forwarding request message from the first wireless network to the subscriber server responsive to a call forwarding condition being detected, wherein the first call forwarding request message is in a first messaging protocol;
converting, in the subscriber server, the first call forwarding request message in the first messaging protocol of the first wireless network to a second call forwarding request message in a second messaging protocol of the second wireless network;
transmitting the second call forwarding request message in the second messaging protocol from the subscriber server to the second wireless network; and
initiating forwarding of the call in the second wireless network responsive to the second call forwarding request message.

11. The method of claim 10 wherein initiating forwarding of the call further comprises:
transmitting a query from the second wireless network to the subscriber server to determine where to forward the call;
receiving a response to the query in the second wireless network that includes forwarding information for the call; and
forwarding the call in the second wireless network according to the forwarding information.

12. The method of claim 10 wherein transmitting the second call forwarding request message further comprises:
identifying forwarding information for the call in the subscriber server responsive to receiving the first call forwarding request message; and
including the forwarding information in the second call forwarding request message.

13. The method of claim 10 wherein converting the first call forwarding request message comprises:
identifying the first messaging protocol of the first wireless network;
identifying the second messaging protocol of the second wireless network;
generating the second call forwarding request message; and
mapping parameters in the first call forwarding request message in the first messaging protocol to parameters in the second call forwarding request message in the second messaging protocol.

14. The method of claim 10 wherein converting the first call forwarding request message comprises converting the first call forwarding request message in a GSM MAP protocol to the second call forwarding request message in an ANSI protocol, or vice-versa.

15. The method of claim 10 wherein converting the first call forwarding request message comprises converting the first call forwarding request message in a GSM MAP protocol to the second call forwarding request message in Session Initiation Protocol (SIP), or vice-versa.

16. The method of claim 10 wherein converting the first call forwarding request message comprises converting the first call forwarding request message in an ANSI protocol to the second call forwarding request message in Session Initiation Protocol (SIP), or vice-versa.

17. The method of claim 10 wherein the call forwarding condition comprises one of a call forwarding don't answer or a call forwarding busy.

18. A method of operating a subscriber server accessible to a first wireless network and a second wireless network, the method comprising:
receiving a first call forwarding request message in a first messaging protocol from the first wireless network responsive to the first wireless network detecting a call forwarding condition when attempting to connect a call directed to the wireless device, wherein the call was originated in the second wireless network;
converting the first call forwarding request message in the first messaging protocol of the first wireless network to a second call forwarding request message in a second messaging protocol of the second wireless network; and
transmitting the second call forwarding request message in the second messaging protocol to the second wireless network that originated the call to the wireless device to provide for forwarding of the call in the second wireless network.

19. The method of claim 18 wherein converting the first call forwarding request message comprises:
identifying the first messaging protocol of the first wireless network;
identifying the second messaging protocol of the second wireless network;
generating the second call forwarding request message; and
mapping parameters in the first call forwarding request message in the first messaging protocol to parameters in the second call forwarding request message in the second messaging protocol.

20. The method of claim 18 wherein transmitting the second call forwarding request message further comprises:
identifying forwarding information for the call; and
including the forwarding information in the second call forwarding request message.
